(19) United States
(12) Patent Application Publication
(10) Pub. No.: US 2025/0239581 A1
(43) Pub. Date: Jul. 24, 2025

(54) HIGH SPEED PRODUCTION OF THICK CATHODE ELECTRODE FOR A BATTERY SYSTEM OF AN ELECTRIC VEHICLE

(71) Applicant: GM Global Technology Operations LLC, Detroit, MI (US)

(72) Inventors: Bradley R. Frieberg, Farmington Hills, MI (US); Roland J. Koestner, Plymouth, MA (US); Raffaello Ardanese, Bloomfield Hills, MI (US); James Joseph Deininger, Wyandotte, MI (US)

(21) Appl. No.: 18/421,094

(22) Filed: Jan. 24, 2024

(51) Int. Cl. H01M 4/04; H01M 4/02; H01M 4/36

(52) U.S. Cl. CPC H01M 4/0404; H01M 4/366; H01M 2004/021; H01M 2004/028; H01M 2220/20

(57) ABSTRACT

A vehicle including: an electric motor; and a battery pack electrically coupled to the electric motor, wherein the battery pack includes an electrochemical cell including: a cathode; an anode; and an electrolyte located between the cathode and the anode; wherein the cathode includes a plurality of cathode voxel layers, wherein each of the cathode voxel layers includes a plurality of cathode voxels, and the plurality of cathode voxel layers is disposed on a cathode current collector, and wherein the plurality of cathode voxel layers has a total thickness of 20 micrometers to 500 micrometers.

### INTRODUCTION

The subject disclosure relates to battery cell technologies, and particularly to thick cathodes for electrochemical cells for use in an electric vehicle.

High voltage electrical systems are increasingly used to power the onboard functions of both mobile and stationary systems. For example, in motor vehicles, the demand to increase fuel economy and reduce emissions has led to the development of advanced electric vehicles (EVs). EVs rely upon Rechargeable Energy Storage Systems (RESS), which typically include one or more high voltage battery packs, and an electric drivetrain to deliver power from the battery to the wheels. Battery packs can include any number of interconnected battery modules depending on the power needs of a given application. Each battery module includes a collection of conductively coupled electrochemical cells. The battery pack is configured to provide a Direct Current (DC) output voltage at a level suitable for powering a coupled electrical and/or mechanical load (e.g., an electric motor).

Battery cells include an anode, a cathode, an electrolyte composition, and optionally a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force. The cathode is one of the key components responsible for the electrochemical reactions that occur during charging and discharging processes. Modern automotive high voltage battery packs benefit from high energy density cathodes to improve overall performance and range.

There remains a continuing need for improved cathodes and methods of preparing cathodes for electrochemical cells.

### SUMMARY

An aspect provides a vehicle. The vehicle includes an electric motor and a battery pack electrically coupled to the electric motor, wherein the battery pack includes an electrochemical cell. The electrochemical cell includes a cathode, an anode, and an electrolyte that is located between the cathode and the anode. The cathode includes a plurality of cathode voxel layers. Each of the cathode voxel layers includes a plurality of cathode voxels. The plurality of cathode voxel layers is disposed on a cathode current collector. The plurality of cathode voxel layers has a total (dry) thickness of 20 micrometers (μm) to 500 μm.

In another embodiment, the plurality of cathode voxel layers has a total (dry) thickness of 30 μm to 250 μm.

In another embodiment, each cathode voxel layer of the plurality of cathode voxel layers independently has a thickness of 10 μm to 120 μm.

In another embodiment, the plurality of cathode voxel layers includes a first plurality of cathode voxel layers that is disposed on the cathode current collector, and a second plurality of cathode voxel layers that is disposed on the first plurality of cathode voxel layers. Each cathode voxel layer of the first plurality of cathode voxel layers independently has a thickness of 10 μm to 20 μm, and each cathode voxel layer of the second plurality of cathode voxel layers independently has a thickness of 20 μm to 30 μm.

In another embodiment, the cathode is prepared by providing a donor foil, providing a carrier substrate that is disposed adjacent to the donor foil, providing a current collector defined by an X-Y plane, and activating the optical system to generate a laser beam through the donor foil and the carrier substrate to create a first plurality of cathode voxels. The first plurality of voxels is collected on the current collector to form one or more first cathode voxel layers. The optical system is activated to generate a laser beam through the donor foil and the carrier substrate to create a second plurality of cathode voxels, and the second plurality of cathode voxels are collected on the one or more first cathode voxel layers to form one or more second cathode voxel layers.

In another embodiment, the cathode is further prepared by curing the one or more first cathode voxel layers before forming the one or more second cathode voxel layers.

In another embodiment, the first plurality of cathode voxels includes a first set of cathode voxels and a second set of cathode voxels, and the second plurality of cathode voxels includes a third set of cathode voxels and a fourth set of cathode voxels. The first set of cathode voxels are spaced apart from the second set of cathode voxels along the X-Y plane, or the first set of cathode voxels at least partially overlap with the second set of cathode voxels along the X-Y plane. The third set of cathode voxels are spaced apart from the fourth set of cathode voxels along the X-Y plane, or the third set of cathode voxels at least partially overlap with the fourth set of cathode voxels along the X-Y plane.

In another embodiment, the first set of cathode voxels have a first thickness in a Z-direction perpendicular to the X-Y plane, the second set of cathode voxels have a second thickness in a Z-direction perpendicular to the X-Y plane, the third set of cathode voxels have a third thickness in a Z-direction perpendicular to the X-Y plane, and the fourth set of cathode voxels have a fourth thickness in a Z-direction perpendicular to the X-Y plane. The first thickness is greater than the second thickness, and the third thickness is greater than the fourth thickness.

Another aspect provides an electrochemical cell. The electrochemical cell includes a cathode, an anode, and an electrolyte that is located between the cathode and the anode. The cathode includes a plurality of cathode voxel layers, wherein each of the cathode voxel layers includes a plurality of cathode voxels, and the plurality of cathode voxel layers is disposed on a cathode current collector. The plurality of cathode voxel layers has a total (dry) thickness of 20 μm to 500 μm.

In another embodiment of the electrochemical cell, the plurality of cathode voxel layers has a total (dry) thickness of 30 μm to 250 μm.

In another embodiment of the electrochemical cell, each cathode voxel layer of the plurality of cathode voxel layers independently has a thickness of 10 μm to 120 μm.

In another embodiment of the electrochemical cell, the plurality of cathode voxel layers includes a first plurality of cathode voxel layers disposed on the cathode current collector, and a second plurality of cathode voxel layers disposed on the first plurality of cathode voxel layers. Each cathode voxel layer of the first plurality of cathode voxel layers independently has a thickness of 10 μm to 20 μm. Each cathode voxel layer of the second plurality of cathode voxel layers independently has a thickness of 20 μm to 30 μm.

In another embodiment of the electrochemical cell, the cathode is prepared by providing a donor foil, providing a carrier substrate that is disposed adjacent to the donor foil, providing a current collector defined by an X-Y plane, and activating the optical system to generate a laser beam through the donor foil and the carrier substrate to create a first plurality of cathode voxels. The first plurality of voxels is collected on the current collector to form one or more first cathode voxel layers. The optical system is activated to generate a laser beam through the donor foil and the carrier substrate to create a second plurality of cathode voxels, and the second plurality of cathode voxels are collected on the one or more first cathode voxel layers to form one or more second cathode voxel layers.

In another embodiment of the electrochemical cell, the first plurality of cathode voxels includes a first set of cathode voxels and a second set of cathode voxels, and the second plurality of cathode voxels includes a third set of cathode voxels and a fourth set of cathode voxels. The first set of cathode voxels are spaced apart from the second set of cathode voxels along the X-Y plane, or the first set of cathode voxels at least partially overlap with the second set of cathode voxels along the X-Y plane. The third set of cathode voxels are spaced apart from the fourth set of cathode voxels along the X-Y plane, or the third set of cathode voxels at least partially overlap with the fourth set of cathode voxels along the X-Y plane.

In another embodiment of the electrochemical cell, the first set of cathode voxels have a first thickness in a Z-direction perpendicular to the X-Y plane, the second set of cathode voxels have a second thickness in a Z-direction perpendicular to the X-Y plane, the third set of cathode voxels have a third thickness in a Z-direction perpendicular to the X-Y plane, and the fourth set of cathode voxels have a fourth thickness in a Z-direction perpendicular to the X-Y plane. The first thickness is greater than the second thickness, and the third thickness is greater than the fourth thickness.

Another aspect provides a method of preparing a cathode of an electrochemical cell for an electric vehicle. The electrochemical cell includes the cathode, an anode, and an electrolyte that is located between the cathode and the anode. The cathode is prepared by providing a donor foil, providing a carrier substrate that is disposed adjacent to the donor foil, providing a current collector defined by an X-Y plane, and activating the optical system to generate a laser beam through the donor foil and the carrier substrate to create a first plurality of cathode voxels. The first plurality of voxels is collected on the current collector to form one or more first cathode voxel layers. The optical system is activated to generate a laser beam through the donor foil and the carrier substrate to create a second plurality of cathode voxels, and the second plurality of cathode voxels are collected on the one or more first cathode voxel layers to form one or more second cathode voxel layers. The one or more first cathode voxel layers and the one or more second cathode voxel layers have a total (dry) thickness of 20 μm to 500 μm.

In an embodiment of the method, the one or more first cathode voxel layers and the one or more second cathode voxel layers have a total (dry) thickness of 30 μm to 250 μm.

In another embodiment of the method, each of the one or more first cathode voxel layers independently has a thickness of 10 μm to 120 μm.

In another embodiment of the method, the first plurality of cathode voxels includes a first set of cathode voxels and a second set of cathode voxels, and the second plurality of cathode voxels includes a third set of cathode voxels and a fourth set of cathode voxels. The first set of cathode voxels are spaced apart from the second set of cathode voxels along the X-Y plane, or the first set of cathode voxels at least partially overlap with the second set of cathode voxels along the X-Y plane. The third set of cathode voxels are spaced apart from the fourth set of cathode voxels along the X-Y plane, or the third set of cathode voxels at least partially overlap with the fourth set of cathode voxels along the X-Y plane.

In another embodiment of the method, the first set of cathode voxels have a first thickness in a Z-direction perpendicular to the X-Y plane, the second set of cathode voxels have a second thickness in a Z-direction perpendicular to the X-Y plane, the third set of cathode voxels have a third thickness in a Z-direction perpendicular to the X-Y plane, and the fourth set of cathode voxels have a fourth thickness in a Z-direction perpendicular to the X-Y plane. The first thickness is greater than the second thickness, and the third thickness is greater than the fourth thickness.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle configured in accordance with one or more embodiments;

FIG. 2A is a schematic diagram of the eLIFT system used to prepare cathodes according to one or more embodiments;

FIG. 2B is a schematic diagram of a portion of the eLIFT system of FIG. 1 and the resultant cathode voxel layer according to one or more embodiments;

FIG. 3A is a schematic diagram of an exemplary cathode voxel layer according to one or more embodiments;

FIG. 3B is a schematic diagram of an exemplary cathode voxel layer according to one or more embodiments;

FIG. 3C is a schematic diagram of an exemplary cathode voxel layer according to one or more embodiments;

FIG. 3D is a schematic diagram of an exemplary cathode voxel layer according to one or more embodiments;

FIG. 3E is a schematic diagram of an exemplary cathode voxel layer according to one or more embodiments;

FIG. 3F is a schematic diagram of an exemplary cathode voxel layer according to one or more embodiments;

FIG. 3G is a schematic diagram of an exemplary cathode voxel layer according to one or more embodiments;

FIG. 3H is a schematic diagram of an exemplary cathode voxel layer according to one or more embodiments;

FIG. 4 is a schematic diagram of a portion of the eLIFT system and the resultant plurality of cathode voxel layers according to one or more embodiments;

FIG. 5 is a simplified configuration of an electrochemical cell of a battery pack in accordance with one or more embodiments;

FIG. 6A is a topographic diagram showing the roughness (top) and thickness profile (bottom) of a single cathode voxel layer formed by the eLIFT cathode system;

FIG. 6B is a topographic diagram showing the roughness (top) and thickness profile (bottom) of two cathode voxel layers formed by the eLIFT cathode system;

FIG. 7 is a graph of roughness (micrometers, mm) versus roughness (S) value (Sq, Sp, Sv, Sz, and Sa) for cathodes prepared by the eLIFT cathode system;

FIG. 8 is a graph of discharge capacity (milliampere hours per square centimeter, mAh/cm²) versus number of cycles (C) for electrochemical cells including a cathode prepared by the eLIFT cathode system or a comparative cathode prepared by a wet slurry coating method;

FIG. 9A is a graph of fluorine signal intensity (counts, cps) versus distance (micrometers, μm) as determined by electron probe microanalysis (EPMA) using an average of 5 positions selected at random for an 85 μm-thick cathode layer prepared by the eLIFT cathode system according to one or more embodiments;

FIG. 9B is a graph of fluorine signal intensity (cps) versus distance (μm) as determined by electron probe microanalysis (EPMA) using an average of 5 positions selected at random for a 175 μm-thick cathode layer prepared by the eLIFT cathode system according to one or more embodiments; and

FIG. 9C is a graph of fluorine signal intensity (cps) versus distance (μm) as determined by electron probe microanalysis (EPMA) using an average of 5 positions selected at random for a 190 μm-thick comparative cathode layer prepared by a wet slurry coating method.

### DETAILED DESCRIPTION

The following description is merely exemplary in nature and is not intended to limit the present disclosure, its application or uses.

The present disclosure applies an Electrode Laser Induced Forward Electrode Transfer (eLIFT) process, and eLIFT formulations, to create high energy density cathodes for electrochemical cells for use in the automotive industry. The eLIFT printing process creates a surface geometry and a roughness pattern using a combination of eLIFT printing parameters in combination with tuning the density of the cathode formulation. As provided herein, the cathodes include a plurality of cathode voxel layers, wherein each of the cathode voxel layers includes a plurality of cathode voxels, such that the plurality of cathode voxel layers has a total (dry) thickness of 20 to 500 micrometers (μm). The eLIFT electrode product may be readily detectable through profilometer-microscopy methods due to the ability to create unique surface geometries through the customized combinations.

These unique combinations give one the ability to control surface geometry based on printer parameters, material density, voxel overlap, and gradient layers with a much higher degree compared to roll-to-roll methods. Other conventional methods such as roll-to-roll (R2R) have difficulty achieving such architectures with high reproducibility. Furthermore, other additive manufacturing process such as extrusion or ink-jet printing make it difficult to create battery electrodes due to inherent process limitations on material properties such as viscosity and particle size making many electrode materials difficult for printing.

According to an aspect, provided is a vehicle that includes an electric motor and a battery pack that is electrically coupled to the electric motor. The battery pack includes an electrochemical cell, which is described in further detail herein, wherein the electrochemical cell includes a cathode, an anode, and an electrolyte that is located between the cathode and the anode. The cathode includes a plurality of cathode voxel layers, where the cathode voxel layers are disposed on a cathode current collector to have a total (dry) thickness of 20 to 500 micrometers (μm).

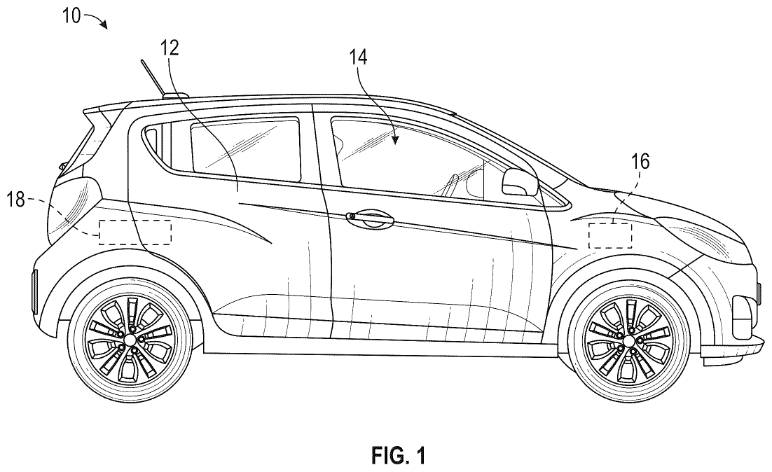

The vehicle, in accordance with an exemplary embodiment, is indicated generally at 10 in FIG. 1. The vehicle 10 is shown in the form of an automobile having a body 12. The body 12 includes a passenger compartment 14 within which are arranged a steering wheel, front seats, and rear passenger seats (not separately indicated). Within the body 12 may be arranged a number of components, including, for example, an electric motor 16 (shown by projection under the front hood). The electric motor 16 is shown for ease of illustration and discussion only. It should be understood that the configuration, location, size, arrangement, or the like, of the electric motor 16 is not meant to be particularly limited, and all such configurations (including multi-motor configurations) are within the contemplated scope of this disclosure.

The electric motor 16 is powered via a battery pack 18 (shown by projection near the rear of the vehicle 10). The battery pack 18 is shown for ease of illustration and discussion only. It should be understood that the configuration, location, size, arrangement, or the like, of the battery pack 18 is not meant to be particularly limited, and all such configurations (including split configurations) are within the contemplated scope of this disclosure. Moreover, while embodiments are discussed in the context of a battery pack 18 configured for the electric motor 16 of the vehicle 10, aspects described herein can be similarly incorporated within any system (vehicle, building, or otherwise) having an energy storage system(s) (e.g., one or more battery packs or modules), and all such configurations and applications are within the contemplated scope of this disclosure.

As will be appreciated, the vehicle may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles. In some embodiments, the vehicle may be a train, a truck, a watercraft, an aircraft, and/or one or more other types of vehicles.

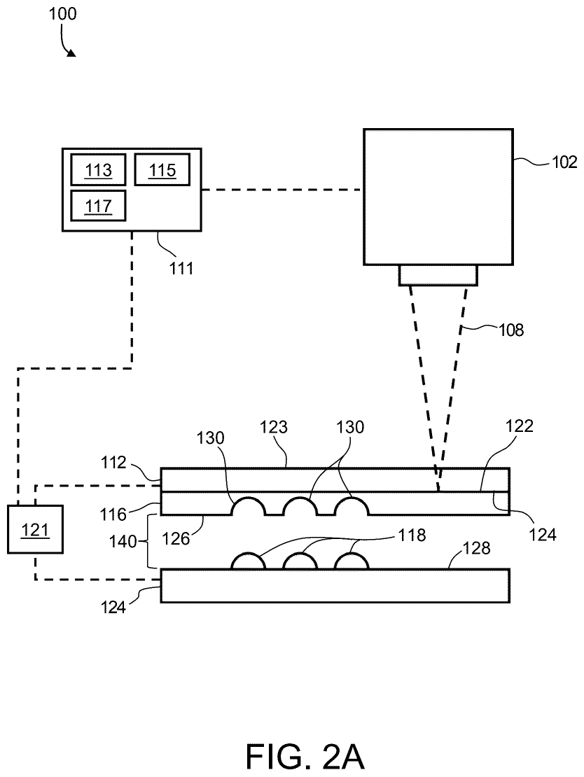

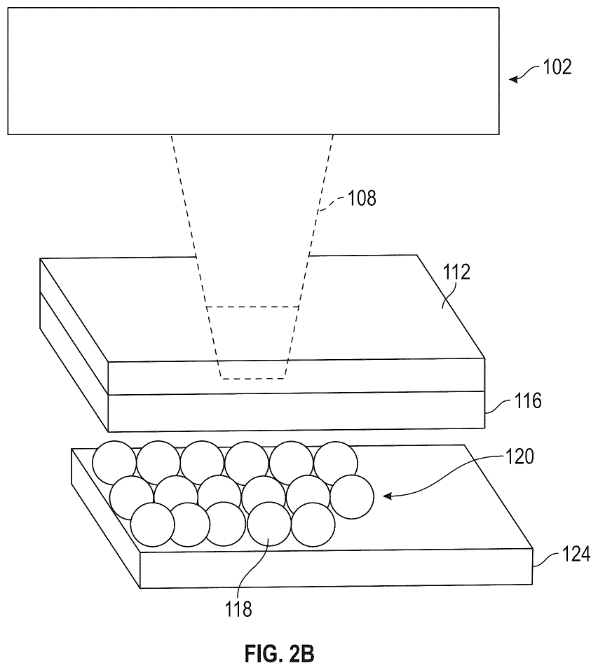

As discussed herein, in some embodiments, the battery pack 18 includes a cathode including a plurality of cathode voxel layers, wherein each of the cathode voxel layers comprises a plurality of cathode voxels, and the plurality of cathode voxel layers is disposed on a cathode current collector. Example fabrication processes for the cathodes are discussed in greater detail with respect to FIGS. 2A, 2B, 3A to 3H, and 4.

In the cathode, the plurality of cathode voxel layers has a total (dry) thickness of 20 to 500 μm. For example, the plurality of cathode voxel layers may have a total (dry) thickness of 20 to 300 μm, 30 to 300 μm, 30 to 250 μm, 30 to 200 μm, 30 to 150 μm, 40 to 200 μm, 50 to 200 μm, 60 to 200 μm, 70 to 200 μm, 80 to 200 μm, or 85 to 190 μm. In some embodiments, each cathode voxel layer of the plurality of cathode voxel layers may independently have a thickness of 10 to 120 μm. For example, each cathode voxel layer of the plurality of cathode voxel layers may independently have a thickness of 10 to 90 μm, 10 to 80 μm, 10 to 70 μm, 10 to 60 μm, 10 to 50 μm, 10 to 40 μm, 10 to 30 μm, 12 to 30 μm, 15 to 30 μm, or 20 to 30 μm.

The plurality of cathode voxel layers may include any number of suitable layers to achieve a desired total thickness. Each of the cathode voxel layers may have the same thickness or a different thickness than the other cathode voxel layers. For example, the plurality of voxel layers may include a first plurality of cathode voxel layers that are disposed on the cathode current collector and a second plurality of cathode voxel layers that are disposed on the first plurality of cathode voxel layers, where each cathode voxel layer in the first plurality of cathode voxel layers has a thickness that is different from a thickness of each of the cathode voxel layers in the second plurality of cathode voxel layers. In some embodiments, the plurality of cathode voxel layers may include a first plurality of cathode voxel layers that are disposed on the cathode current collector and a second plurality of cathode voxel layers that are disposed on the first plurality of cathode voxel layers, where each cathode voxel layer of the first plurality of cathode voxel layers independently has a thickness of 10 to 20 μm, and each cathode voxel layer of the second plurality of cathode voxel layers independently has a thickness of 20 to 30 μm. In some aspects, the cathode voxel layers in the first plurality of cathode voxel layers may each have a thickness that is less than a thickness of each cathode voxel layer of the second plurality of cathode voxel layers. Any number of variations are contemplated, including three or more different pluralities of cathode voxel layers, wherein the thickness of the cathode voxel layers in each of the plurality of voxel layers is different from the others.

The cathode of the electrochemical cell may be prepared using Electrode Laser Induced Forward Electrode Transfer (eLIFT), as described herein. The cathode may be prepared by providing a donor foil, providing a carrier substrate disposed adjacent to the donor foil, providing an optical system, and providing a current collector defined by an X-Y plane. The optical system may be activated to generate a laser beam through the donor foil and the carrier substrate to create a first plurality of cathode voxels, where the first plurality of cathode voxels may be collected on the current collector to form one or more first cathode voxel layers. The optical system may then be activated again to generate a laser beam through the donor foil and the carrier substrate to create a second plurality of cathode voxels, where the second plurality of cathode voxels may be collected on the first plurality of cathode voxels to form one or more second cathode voxel layers. Optionally, one or more additional cathode voxel layers, or one or more additional pluralities of cathode voxel layers, may be further deposited to form the cathode product.

Referring to FIGS. 2A and 2B, an eLIFT cathode system 100 is generally shown. The system 100 utilizes a laser-induced forward transfer (LIFT) printing technique for deposition of component materials. The system 100 includes a laser generating source 102 configured to produce a laser beam 108, a donor substrate 112, a donor layer 116 coated or otherwise applied to surfaces of the donor substrate 112, and a receiving substrate 124 spaced apart from the surfaces of the donor substrate 112 having the donor layer 116 applied thereto. For convenience, the system 100 will be described relative to the orientation represented in FIG. 1; however, the system 100 is not necessarily limited to such orientation. As such, the donor substrate 112 is referred to herein as having an upper or top surface 123 facing the laser generating source 102 and a lower or bottom surface 122 facing the receiving substrate 124 and having the donor layer 116 applied thereto, the donor layer 116 is referred to herein as having an upper or top surface 124 in contact with lower surface 122 of the donor substrate 112 and a lower or bottom surface 126 facing opposite the upper surface 124 thereof, and the receiving substrate 124 is referred to as having an upper or top surface 128 facing the lower surface 126 of the donor layer 116 thereon.

In general, the system 100 may be operated to selectively deposit material of the donor layer 116, referred to herein as donor material, onto the upper surface 128 of the receiving substrate 124. More specifically, the laser generating source 102 may generate and direct the laser beam 108 toward the upper surface 123 of the donor substrate 112. The laser beam 108 may be modified, directed, and/or focused on an interface between the donor substrate 112 and the donor layer 116, for example, by optical elements such as mirrors, beam splitters, and/or lenses. Operation of the system 100 including, for example, controlling the laser generating source 102, any other components for modifying, directing, and/or focusing the laser beam 108 (e.g., scanners with galvanometric mirrors, lens, etc.), and any components for moving the donor substrate 112 and/or the receiving substrate 124 (e.g., motion stages) may be controlled by a controller 111.

The controller 111 includes at least one processor 113, a communication bus 115, and a computer readable storage device or media 117. The processor 113 performs the computation and control functions of the controller 111. The processor 113 can be any custom made or commercially available processor, a central processing unit (CPU), a graphics processing unit (GPU), an auxiliary processor among several processors associated with the controller 111, a semiconductor-based microprocessor (in the form of a microchip or chip set), a macroprocessor, any combination thereof, or generally any device for executing instructions. The computer readable storage device or media 117 may include volatile and nonvolatile storage in read-only memory (ROM), random-access memory (RAM), and keep-alive memory (KAM), for example. KAM is a persistent or nonvolatile memory that may be used to store various operating variables while the processor 113 is powered down. The computer-readable storage device or media 117 may be implemented using any of a number of known memory devices such as PROMs (programmable read-only memory), EPROMs (electrically PROM), EEPROMs (electrically erasable PROM), flash memory, or any other electric, magnetic, optical, or combination of memory devices capable of storing data, some of which represent executable instructions, used by the controller 111 in controlling the system 100. The bus 115 serves to transmit programs, data, status and other information or signals between the various components of the system 100. The bus 115 can be any suitable physical or logical means of connecting computer systems and components. This includes, but is not limited to, direct hard-wired connections, fiber optics, infrared, and wireless bus technologies.

The instructions may include one or more separate programs, each of which includes an ordered listing of executable instructions for implementing logical functions. The instructions, when executed by the processor 113, receive and process signals, perform logic, calculations, methods and/or algorithms, and generate data based on the logic, calculations, methods, and/or algorithms. Although only one controller 111 is shown in FIG. 2, embodiments of the system 100 can include any number of controllers 111 that communicate over any suitable communication medium or a combination of communication mediums and that cooperate to process the sensor signals, perform logic, calculations, methods, and/or algorithms, and generate data.

The controller 111 may otherwise differ from the embodiment shown in FIG. 2A. For example, the controller 111 may be coupled to or may otherwise utilize one or more remote computer systems and/or other control systems, for example as part of one or more of the above-identified devices and systems. It will be appreciated that while this exemplary embodiment is described in the context of a fully functioning computer system, those skilled in the art will recognize that the mechanisms are capable of being distributed as a program product with one or more types of non-transitory computer-readable signal bearing media used to store the program and the instructions thereof and carry out the distribution thereof, such as a nontransitory computer readable medium bearing the program and containing computer instructions stored therein for causing a computer processor (such as the processor 113) to perform and execute the program. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 111 may also otherwise differ from the embodiment depicted in FIG. 2A, for example in that the computer system of the controller 111 may be coupled to or may otherwise utilize one or more remote computer systems and/or other control systems.

The wavelength of the laser beam 108 may, and preferably does, substantially match or is similar to the transparency of the donor substrate 112 and an absorption ability of the donor layer 116. With such arrangement, the laser beam 108 may pass through the donor substrate 112 and irradiate the donor layer 116 thereon.

Portions 130 of the donor layer 116 irradiated by the laser beam 108 may be ejected from the donor layer 116 and controllably deposited on the receiving substrate 124. As used herein, the individual deposited materials are referred to as cathode voxels 118. Patterns of the cathode voxels 118 may be formed by scanning and/or rastering the laser beam 108 (e.g., by scanners with galvanometric mirrors) and/or by moving the donor substrate 112 and/or the receiving substrate 124 (e.g., with a motion stage 121). In various embodiments, the laser beam 108 may be scanned over the donor layer 116 at a rate of 20 to 50 meters per second (m/s).

In various embodiments, the lower surface 122 of the donor substrate 112 and/or the lower surface 126 of the donor layer 116 thereon are oriented substantially parrel to the upper surface 128 of the receiving substrate 124 prior to operation of the laser generating source 102. A gap or spacing 140 between the donor layer 116 and the receiving substrate 124 may be between, for example, a few tenths of a micron to a few millimeters, depending on the composition of the donor material. For example, non-Newtonian inks may require a narrower space 140 whereas Newtonian inks may allow for a wider space 140. In some embodiments, the laser beam 108 is directed to be substantially perpendicular to the lower surface 122 of the donor substrate 112. In other embodiments, the laser beam 108 is directed toward the donor substrate 112 at an angle that is not perpendicular to the lower surface 122 of the donor substrate 112.

In various embodiments, the laser generating source 102 may be configured to pulse the laser beam 108, for example, having a laser repetition rate (i.e., pulses) of several nanoseconds, picoseconds, or femtoseconds. In some embodiments, the laser generating source 102 is configured to produce a continuous wave laser beam 108. The laser beam 108 may be generated at various wavelengths. The laser beam 1108 may be generated to have a power of about a few milliwatts to several hundred watts.

The system 100 may be configured to controllably deposit the donor material by controlling various parameters of the system 100. In some embodiments, the system 100 is configured to deposit the cathode voxels 118 to overlap, having a dots-per-inch of about 5% to about 90%.

The donor substrate 112 is primarily provided to mechanically support the donor layer 116 and therefore may be configured to be at least moderately rigid relative to the donor material. As the donor substrate 112 is also preferably substantially transparent to the laser beam 108, suitable materials for the donor substrate 112 may include various glass materials (e.g., for near-infrared and visible wavelengths), quartz or fused silica (e.g., for ultra-violet wavelengths), or various polymeric materials such as polyethylene terephthalate (PET). The donor substrate 112 may have various cross-sectional thicknesses, such as about 5 to 1,000 micrometers (μm).

The donor layer 116 may be applied to the donor substrate 112 with various techniques. In some embodiments, a thin layer of ink including the donor material may be uniformly applied on the lower surface 122 of the donor substrate 112. Exemplary techniques for application of the ink may include, but are not limited to, spin-coating, blade-coating, or with a continuous ink feeding system, such as a roll-to-roll (R2R) coating system.

To cause ejection of the portions 130 of the donor layer 116 irradiated by the laser beam 108, the ink may include at least one component that is configured to absorb radiation at the wavelength of the laser beam 108. Alternatively, or in addition, non-linear absorption may be promoted by using femtosecond laser beam pulses. In various embodiments, a thin intermediate (sacrificial) layer may be located between the donor substrate 112 and the donor layer 116 that is configured to absorb radiation at the wavelength of the laser beam 108. The intermediate layer may be, for example, a thin film (e.g., tens to hundreds of nanometers) of various metallic and polymeric materials that are configured to decompose during deposition to minimize contamination on the receiving substrate 124. In some embodiments, the ink may include an active material, a solvent, and optionally one or more additional materials such as a binder. In such embodiments, the ink may include between about 5 to 20 weight percent (wt %) active material and 5 to 75 wt % solvent. Nonlimiting examples of active materials include, but are not limited to, graphite, and carbon black. The donor layer 116 may have various cross-sectional thicknesses, such as about 5 to 1,000 micrometers (μm).

The receiving substrate 124 may include one or more materials including but not limited to various metallic materials. In some embodiments, the receiving substrate 124 may include materials similar to those used to produce battery components with various other techniques, such as roll-to-roll (R2R) coating. Nonlimiting examples of the receiving substrate 124 include, but are not limited to, copper or an alloy thereof, aluminum or an alloy thereof, and certain polymer substrates. The receiving substrate 124 may have various cross-sectional thicknesses, such as about 5 to 1,000 micrometers (μm).

The optical system 102 may generate a laser beam 108 through the donor foil 112 and the cathode material 116 to create a cathode voxel 118 that is received on a current collector 124, such as a current collector foil, which defines an X-Y plane. Several cathode voxels 118 create a cathode voxel layer 120, as shown in FIG. 2B. Each cathode voxel layer 120 can be created with a variety of different densities, resolutions (e.g., overlapping of voxels), depositions, or the like.

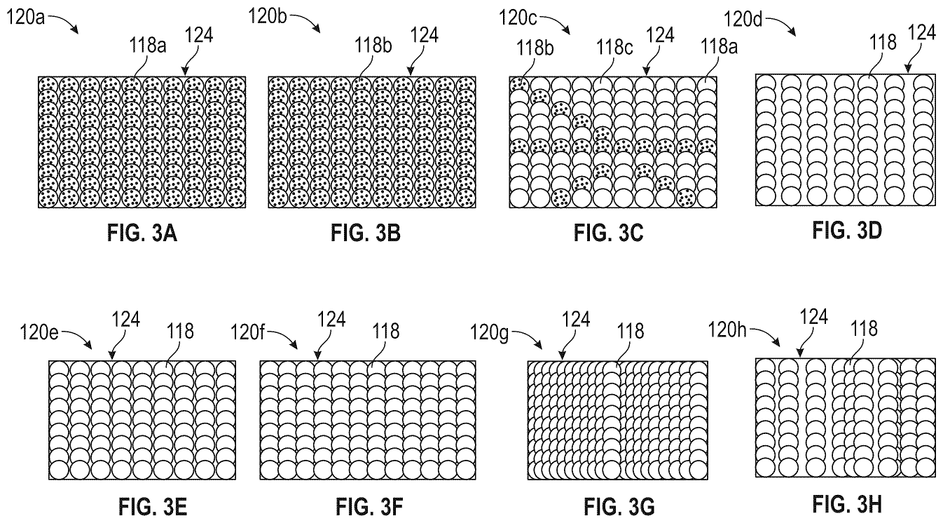

FIGS. 3A to 3H show various configurations for the cathode voxel layers that may be formed selectively and independently in each layer of the plurality of cathode voxel layers. FIG. 3A shows a cathode voxel layer 120a that includes a series of first cathode voxels 118a without any dilution. FIG. 3B shows a cathode voxel layer 120b that includes a series of second cathode voxels 118b including 10 wt % dilution in a solvent. FIG. 3C shows a cathode voxel layer 120c that includes a series of first cathode voxels 118a without any dilution, a series of second cathode voxels 118b including 10 wt % dilution in a solvent, and a series of third cathode voxels 118c including 20 wt % dilution in a solvent, wherein the series of cathode voxels 118a, 118b, 118c may be arranged in any suitable configuration. FIG. 3D shows a cathode voxel layer 120d that includes cathode voxels 118 that are arranged in rows along the X-Y plane, wherein the cathode voxels 118 are spaced apart from each other by a first distance. FIG. 3E shows a cathode voxel layer 120e that includes cathode voxels 118 that are arranged in rows along the X-Y plane, wherein the cathode voxels 118 are spaced apart from each other by a second distance, where the second distance is less than the first distance in FIG. 3D. FIG. 3F shows a cathode voxel layer 120f that includes cathode voxels 118 that are overlapped with each other by a first degree of overlap. FIG. 3G shows a cathode voxel layer 120g that includes cathode voxels 118 that are overlapped with each other by a second degree of overlap, where the second degree of overlap is greater than the first degree of overlap in FIG. 3F. FIG. 3H shows a cathode voxel layer 120h that includes cathode voxels 118 that are at least partially overlapped with each other, for example wherein the degree overlap varies within the cathode voxel layer 120h. The configurations shown in FIGS. 3A to 3H may be used to adjust and control the resolution of each cathode voxel layer in the plurality of voxel layers.

In some embodiments, the first plurality of cathode voxels may include a first set of cathode voxels and a second set of cathode voxels, and the second plurality of cathode voxels may include a third set of cathode voxels and a fourth set of cathode voxels, wherein the sets of cathode voxels are the same or different. In some embodiments, the first set of cathode voxels may be spaced apart from the second set of cathode voxels along the X-Y plane, or the first set of cathode voxels may be at least partially overlapping with the second set of cathode voxels along the X-Y plane. In some embodiments, the third set of cathode voxels may be spaced apart from the fourth set of cathode voxels along the X-Y plane, or the third set of cathode voxels may be at least partially overlapping with the fourth set of cathode voxels along the X-Y plane. In some embodiments, the first set of cathode voxels may have a first thickness in a Z-direction perpendicular to the X-Y plane, the second set of cathode voxels may have a second thickness in a Z-direction perpendicular to the X-Y plane, the third set of cathode voxels may have a third thickness in a Z-direction perpendicular to the X-Y plane, the fourth set of cathode voxels may have a fourth thickness in a Z-direction perpendicular to the X-Y plane, the first thickness may be greater than the second thickness, and wherein the third thickness may be greater than the fourth thickness.

In some embodiments, the cathode voxels in each cathode voxel layer may be formed with a specified degree of overlap or without overlap. As noted above, in some embodiments, the cathode voxels in a cathode voxel layer may include regions having cathode voxel overlap and regions where there is no overlap. In some embodiments, the cathode voxels may have a degree of overlap that is 0% (no overlap) to 75%, for example, a 15% to 75% degree of overlap, or a 25% to 75% degree of overlap, but embodiments are not limited thereto.

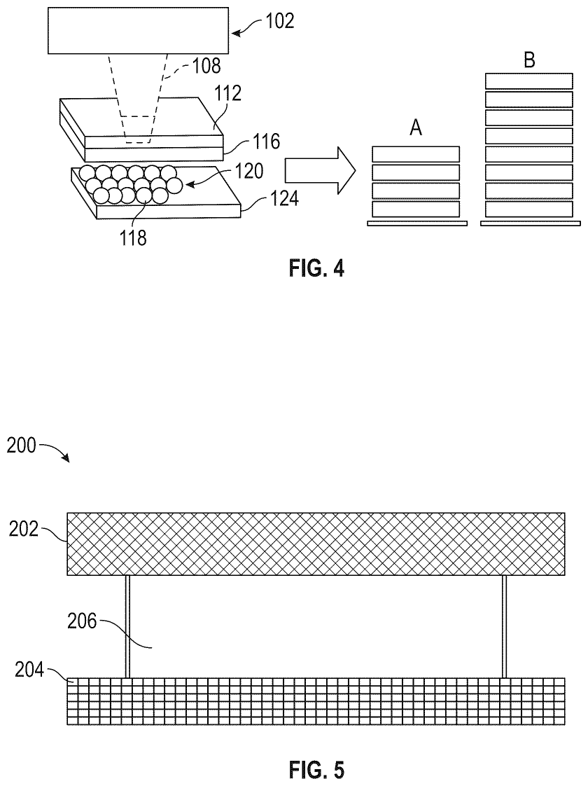

FIG. 4 shows the eLIFT cathode system shown in FIG. 2B being used to prepare a plurality of cathode voxel layers. The embodiment labeled “A” includes four cathode voxel layers to provide, for example, a total height of about 100 μm. The embodiment labeled “B” includes eight cathode voxel layers to provide, for example, a total height of about 200 μm. However, embodiments are not limited thereto, and any suitable number of cathode voxel layers may be used. For example, the plurality of cathode voxel layers may include 2 to 25 cathode voxel layers, 4 to 20 cathode voxel layers, 4 to 15 cathode voxel layers, or 4 to 10 cathode voxel layers. In addition, as noted here, the plurality of cathode voxel layers may be subdivided into two or more sets of voxels layers, such as a first plurality of cathode voxel layers and a second plurality of cathode voxel layers.

In some embodiments, the cathode may be further prepared by curing the one or more first cathode voxel layers before forming the one or more second cathode voxel layers thereon. For example, the first plurality of cathode voxels may be collected on the current collector to form one or more first cathode voxel layers, and then the one or more first cathode voxel layers may be cured before the second plurality of cathode voxels are deposited thereon. In some embodiments, the cathode voxel layer may be cured after each layer is formed, whereas in other embodiments, the plurality of cathode voxel layers may be cured after every 2-10 layers have been added, such as every 2-6 layers, or every 2-4 layers. In some embodiments, the one or more first cathode layers are cured before the one or more second cathode layers are added thereto.

Also provided is an electrochemical cell including a cathode, an anode, and an electrolyte located between the cathode and the anode. The cathode includes a plurality of cathode voxel layers as described herein, wherein each of the cathode voxel layers comprises a plurality of cathode voxels. The plurality of cathode voxel layers is disposed on a cathode current collector such that the plurality of cathode voxel layers has a total (dry) thickness of 20 to 500 μm. The plurality of cathode voxel layers in the electrochemical cell are as described herein for the electrochemical cell of the vehicle, whereas the aspects of the electrochemical cell described below also apply to the electrochemical cell of the vehicle herein.

FIG. 5 illustrates a simplified configuration of an electrochemical cell of a battery pack (e.g., the battery pack 18 of FIG. 1) in accordance with one or more embodiments. As shown in FIG. 5, an electrochemical cell 200 can include a cathode 202 (i.e., a positive electrode), an anode 204 (i.e., a negative electrode), and an electrolyte 206 that is located between the cathode 202 and the anode 204. While only a single electrochemical cell 200 is shown for convenience, it should be understood that a battery pack may include any number of cells as needed to meet battery design constraints (e.g., capacity requirements).

In some embodiments, the active material (also referred to as electroactive material) of the cathode 202 may include a lithium-containing active material that can sufficiently undergo lithium intercalation and deintercalation, alloying and dealloying, and/or plating and stripping, while functioning as the positive terminal of the electrochemical cell 200. The cathode 202 electroactive materials may include one or more transition metals, such as manganese (Mn), nickel (Ni), cobalt (Co), chromium (Cr), iron (Fe), vanadium (V), or a combination thereof. Exemplary lithium-containing active materials include spinel lithium manganese oxide (LiMn₂O₄), lithium cobalt oxide (LiCoO₂), a nickel-manganese oxide spinel (Li(Ni_{0.5}Mn_{1.5})O₂), a layered nickel-manganese-cobalt oxide (having a general formula of xLi₂MnO₃(1-x)LiMO₂, where M is composed of any ratio of Ni, Mn, and/or Co). A specific example of the layered nickel-manganese oxide spinel is xLi₂MnO₃(1-x)Li(Ni_{1/3}Mn_{1/3}CO_{1/3})O₂. Other exemplary lithium-containing cathode active materials include Li(Ni_{1/3}Mn_{1/3}Co_{1/3})O₂), LiNiO₂, Liₓ+yMn₂-yO₄ (LMO, 0<x<1 and 0<y<0.1), a lithium iron polyanion oxide, such as lithium iron phosphate (LiFePO₄) or lithium iron fluorophosphate (Li₂FePO₄F, LFP), or a combination thereof. Other lithium-containing cathode active materials may also be used, such as LiNiₓM₁₋ₓO₂ (M is composed of any ratio of Al, Co, and/or Mg), LiNi₁₋ₓCo_{1-y}M_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂ or NCA), aluminum stabilized lithium manganese oxide spinel (LixMn₂₋ₓAl_{y}O₄), NCMA (LiNi_{1-x-y-z}CoₓMn_{y}Al_{z}O₂) (where 0.02≤x≤0.20, 0.01≤y≤0.12, and 0.01≤z≤0.08), lithium vanadium oxide (LiV₂O₅), Li₂MSiO₄ (M is composed of any ratio of Co, Fe, and/or Mn), a high efficiency nickel-manganese-cobalt material (HE-NMC, NMC, or LiNiMnCoO₂), an olivine LiMnₓFe₍₁₋ₓ₎PO₄ (LMFP), or the like, or a combination thereof. By “any ratio” it is meant that any element may be present in any amount. In another example, anion substitutions may be made in the lattice of any example of the lithium transition metal active material to stabilize the crystal structure. For example, any O atom may be substituted with an F atom. In some embodiments, the cathode includes NCM 111, NCM 532, NCM 622, NCM 712, NCM 811, NCMA, NCA, LNMO, or combination thereof. In some embodiments, the cathode includes NCMA.

In some embodiments, the electrolyte 206 functions as a separator to provide a physical barrier between the cathode 202 and the anode 204. In some embodiments, the electrolyte 206 includes a dendrite-blocking layer, one or more interface layers, and/or one or more electrolyte layers (not separately shown). In some embodiments, the electrolyte 206, in addition to providing a physical barrier between the cathode 202 and the anode 204, can provide a minimal resistance path for the internal passage of lithium ions (and related anions) during cycling of the lithium ions to facilitate functioning of the electrochemical cell 200.

The electrolyte 206 provides a medium for the conduction of lithium ions through the electrochemical cell 200 between the cathode 202 and the anode 204 and may be in solid, liquid, or gel form. In aspects, the electrolyte 206 may include a non-aqueous liquid electrolyte solution including a lithium salt dissolved in a non-aqueous aprotic organic solvent or a mixture of non-aqueous aprotic organic solvents. Non-limiting examples of lithium salts include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C2O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium (triethylene glycol dimethyl ether)bis(trifluoromethanesulfonyl)imide (Li(G₃) (TFSI), lithium bis(trifluoromethanesulfonyl)azanide (LiTFSA), and combinations thereof. Non-limiting examples of non-aqueous aprotic organic solvents include cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ lactones (e.g., γ butyrolactone, γ valerolactone), chain structure ethers (e.g., 1,2 dimethoxyethane, 1 2 diethoxyethane, ethoxymethoxyethane), cyclic ethers (e.g., tetrahydrofuran, 2 methyltetrahydrofuran), 1,3-dioxolane), or the like.

In some embodiments, the electrolyte may be a solid-state electrolyte. The solid-state electrolyte may include one or more solid-state electrolyte particles that may include one or more polymer-containing particles, oxide-containing particles, sulfide-containing particles, halide-containing particles, borate-containing particles, nitride-containing particles, hydride-containing particles, or a combination thereof. Exemplary solid-state electrolytes include, but are not limited to, LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or a combination thereof.

In some embodiments, the anode 204 includes an electroactive material such as a lithium host material capable of functioning as a negative terminal of the electrochemical cell 200. In various aspects, the electroactive material includes lithium and may be a lithium metal. In some embodiments, the anode 204 can include an electroactive lithium host material, such as graphite. In some embodiments, the anode 204 can include an electrically conductive material, as well as one or more polymeric binder materials to structurally hold the graphite material together. Negative electrodes may comprise greater than or equal to about 50% to less than or equal to about 100% of an electroactive material (e.g., graphite or graphite and lithiated silicon oxide blend), optionally less than or equal to about 30% of an electrically conductive material, and a balance binder. For example, in some embodiments, the anode 204 may include an active material including graphite particles intermingled with a binder material that may be polyvinylidene difluoride (PVdF), ethylene propylene diene monomer (EPDM) rubber, and/or carboxymethoxyl cellulose (CMC), a styrene-butadiene rubber (SBR), a compound and/or mixture of CMC and SBR, a nitrile butadiene rubber (NBR), lithium polyacrylate (LiPAA), sodium polyacrylate (NaPAA), sodium alginate, lithium alginate, and combinations thereof, by way of non-limiting examples. Suitable additional electrically conductive materials may include carbon-containing material and/or a conductive polymer. Carbon-containing materials may include, for example, electrically conductive carbon black, electrically conductive acetylene black, acetylene black, carbon black, graphite, graphene, graphene oxides, carbon nanofibers, carbon nanotubes, or the like. Examples of a conductive polymer include polyaniline, polythiophene, polyacetylene, polypyrrole, or the like. In certain aspects, mixtures of these conductive materials may be used.

In some embodiments, the cathode material, or material used to prepare the cathode, may include a solvent, a binder, and/or a slurry stabilizing agent (not separately shown). Solvents can be selected from known materials depending on the choice in the cathode active material. For example, the solvent for NCMA active materials may include N-Methyl-2-pyrrolidone (NMP). Other solvents, such as cyclic carbonates (e.g., ethylene carbonate (EC), propylene carbonate (PC), butylene carbonate (BC), fluoroethylene carbonate (FEC)); acyclic (i.e., linear) carbonates (e.g., dimethyl carbonate (DMC), diethyl carbonate (DEC), ethylmethylcarbonate (EMC)); aliphatic carboxylic esters (e.g., methyl formate, methyl acetate, methyl propionate); γ-lactones (e.g., γ-butyrolactone, γ-valerolactone); chain structure ethers (e.g., 1,2-dimethoxyethane, 1-2-diethoxyethane, ethoxymethoxyethane); cyclic ethers (e.g., tetrahydrofuran, 2-methyltetrahydrofuran, 1,3-dioxolane); or combination thereof, may be used.

The cathode active material may be intermingled with a binder and/or a conductive filler. Suitable binders include polyvinylidene fluoride (PVdF), polyethylene oxide (PEO), an ethylene propylene diene monomer (EPDM) rubber, carboxymethyl cellulose (CMC)), styrene-butadiene rubber (SBR), styrene-butadiene rubber carboxymethyl cellulose (SBR-CMC), polyacrylic acid (PAA), cross-linked polyacrylic acid-polyethylenimine, polyimide, polyvinyl alcohol (PVA), sodium alginate, a combination thereof, or other suitable binders. An example of the conductive filler is a high surface area carbon, such as acetylene black, or the like. The binder may hold the electrode materials together, and the conductive filler may ensure good electron conduction between the positive-side current collector and the active material particles of the cathode.

In some embodiments, the electrochemical cell may further include a separator (not shown). Exemplary separators include a polymeric film, such as a polypropylene film or a coated polypropylene film. The separator may include a polyolefin-containing material having the general formula (CH₂CH_{R})ₙ, where R is an alkyl group. In some embodiments, the separator may include a single polyolefin or a combination of polyolefins. Examples of polyolefins include polyethylene (PE), polypropylene (PP), polyamide (PA), poly(tetrafluoroethylene) (PTFE), polyvinylidene fluoride (PVdF), poly(vinyl chloride) (PVC), and/or polyacetylene. Examples of other polymeric materials that may be included in or used to form the separator include cellulose, polyimide, copolymers of polyolefins and polyimides, poly(lithium 4-styrenesulfonate)-coated polyethylene, polyetherimide (PEI), bisphenol-acetone diphthalic anhydride (BPADA), para-phenylenediamine, poly(m-phenylene isophthalamide) (PMIA), and/or expanded polytetrafluoroethylene reinforced polyvinylidenefluoride-hexafluoropropylene.

The current collector of the cathode and/or the anode may be any suitable electrically conductive material. For example, current collector may include copper, nickel, titanium, platinum, gold, silver, magnesium, aluminum, vanadium, an alloy thereof, or a combination thereof. The current collector may have a thickness of 10 nanometers (nm) to 1000 nm. For example, the current collector may have a thickness of 10 nm to 500 nm, or 50 nm to 400 nm, or 100 nm to 400 nm, but embodiments are not limited thereto.

Also provided is a method of preparing a cathode of an electrochemical cell for an electric vehicle, wherein the electrochemical cell includes the cathode, an anode, and an electrolyte located between the cathode and the anode. The method of preparing the cathode includes providing a donor foil, providing a carrier substrate disposed adjacent to the donor foil, providing an optical system, and providing a current collector defined by an X-Y plane. The optical system is activated to generate a laser beam through the donor foil and the carrier substrate to create a first plurality of cathode voxels, and the first plurality of cathode voxels are collected on a current collector to form one or more first cathode voxel layers. The optical system is then activated again to generate a laser beam through the donor foil and the carrier substrate to create a second plurality of cathode voxels, and the second plurality of cathode voxels are collected on the one or more first cathode layers to form one or more second cathode voxel layers. The one or more first cathode voxel layers and the one or more second cathode voxel layers have a total (dry) thickness of 20 to 500 μm.

In some embodiments, the eLIFT system may be used to prepare a cathode as described herein, including the plurality of cathode voxel layers, at a line speed of 10 meters per minute (m/min) to 60 m/min, 20 m/min to 50 m/min, or 30 m/min to 40 m/min, but embodiments are not limited thereto.

In terms of hardware architecture, the eLIFT system can be implemented in part using a computing device that can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed. The processor may be a hardware device for executing software, particularly software stored in memory. The processor can be a custom made or commercially available processor, a central processing unit (CPU), an auxiliary processor among several processors associated with the computing device, a semiconductor-based microprocessor (in the form of a microchip or chip set), or generally any device for executing software.

The memory can include any one or combination of volatile memory elements (e.g., random access memory (RAM, such as DRAM, SRAM, SDRAM, VRAM, etc.)) and/or nonvolatile memory elements (e.g., ROM, hard drive, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The discharge capacity C (measured in amp-hour, or Ah) of a battery can be evaluated at various currents or, more commonly, at various C rates. The C rate is conventionally used to describe battery loads or battery charging in terms of time to charge or discharge C amp-hour. The C rate has the units of amp (or ampere), A, and is capacity C divided by time in hours. A C rate of 1 C means 1 hour to discharge C amp-hour. Other C rates can be employed to evaluate discharge capacity, such as C/2 (2 hours of discharge), C/6 (6 hours of discharge), C/10 (10 hours of discharge), or the like.

### EXAMPLES

### Example 1

Cathodes were prepared of varying thicknesses using the eLIFT process. The cathode material included NCMA as the active material. The comparative sample was prepared by forming a single cathode voxel layer on a substrate surface, where the cathode voxels were printed with a 75% degree of overlap. The working sample was prepared by forming two cathode voxel layers on the substrate surface, where the cathode voxels were printed with a 75% degree of overlap in each layer. The cathode materials were cured after the NCMA active material layer(s) were applied.

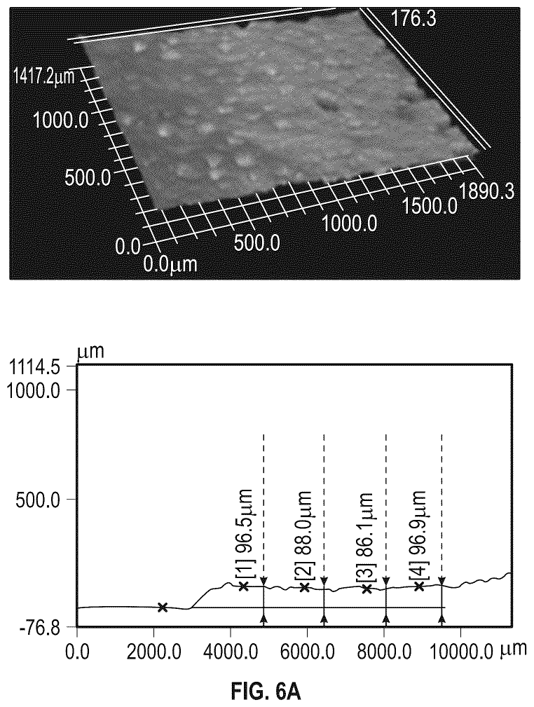

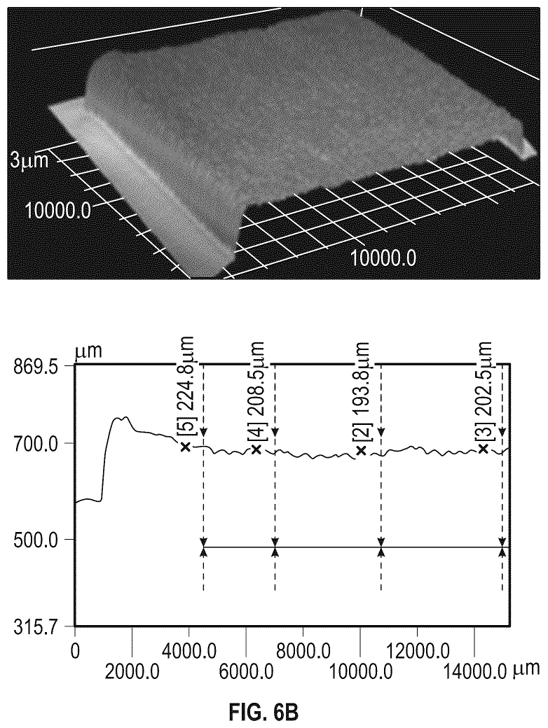

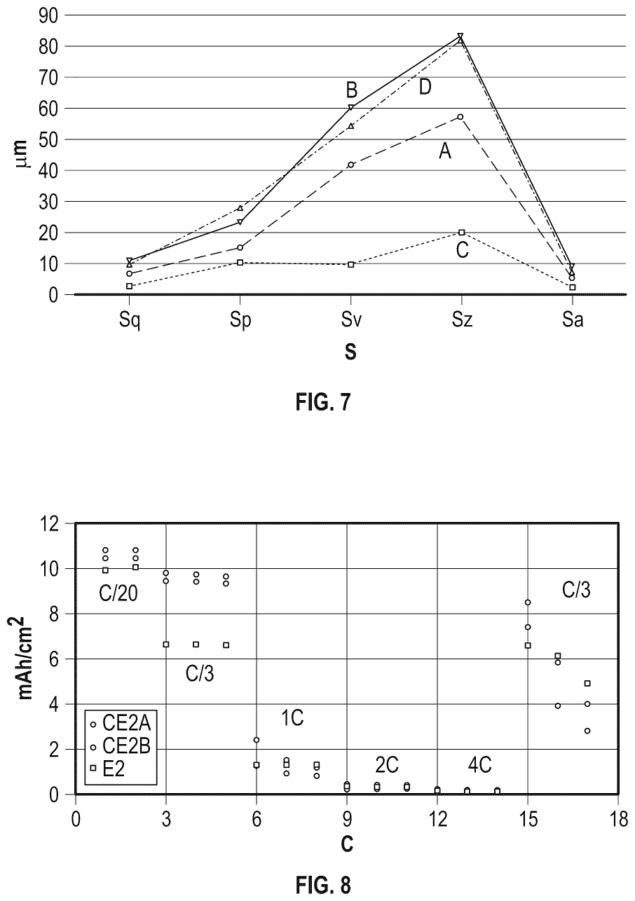

As a comparative sample, FIG. 6A is a topographic diagram showing the surface roughness (top) and the thickness profile (bottom) of a single cathode voxel layer that was formed by the eLIFT cathode system. As a working sample, FIG. 6B is a topographic diagram showing the surface roughness (top) and the thickness profile (bottom) of two cathode voxel layers formed by the eLIFT cathode system. The topographic diagrams show that the surface roughness was decreased when multiple cathode voxel layers were used. This is further shown in FIG. 7, which shows the quantified decrease in surface roughness of the multi-layer working sample “A” compared to the single layer comparative sample “B”. Also shown in FIG. 7 is the baseline roughness “C” and the calculated roughness “D” for the single layer.

### Example 2

A working cathode was prepared using the eLIFT process, where eight cathode layers having a thickness of 22 micrometers each were printed to provide a cathode active material layer having a total dry thickness of 174 micrometers. The cathode voxels were printed with a 75% degree of overlap in each layer. A curing step was performed after every two layers were printed. The cathode material included NCMA as the active material. The resulting cathode was assembled into an electrochemical cell including an anode and an electrolyte.

A comparative cathode was prepared using a wet slurry coating process in NMP as a solvent. The resulting cathode layer had a total dry thickness of 190 micrometers. The cathode material included NCMA as the active material. The resulting comparative cathode was assembled into a comparative electrochemical cell including an anode and an electrolyte.

The discharge capacity to the working electrochemical cell and the comparative electrochemical cell were compared at a variety of discharge rates. FIG. 8 shows the discharge capacity of the working electrochemical cell and the comparative electrochemical cell at C rates of C/20, C/3, 1C, 2C, and 4C over the course of numerous cycles. The charge capacity of the working electrochemical cell (75% overlap, labeled as “E2”) showed equivalent performance to the comparative electrochemical cells (prepared from a traditional slurry method, labelled as “CE2A” and “CE2B”) at most charge rates. It was further noted that the second C/3 cycle for the working electrochemical cell demonstrated less of a decrease in discharge capacity as compared to the comparative electrochemical cell after 15 cycles.

### Example 3

A first working cathode was prepared using the eLIFT process, where four cathode layers were printed to provide a cathode active material layer having a total dry thickness of 85 micrometers. The cathode voxels were printed with a 75% degree of overlap in each layer. A curing step was performed after every two layers were printed. The cathode material included NCMA as the active material. The resulting cathode was assembled into an electrochemical cell including an anode and an electrolyte.

A second working cathode was prepared using the eLIFT process, where eight cathode layers were printed to provide a cathode active material layer having a total dry thickness of 175 micrometers. The cathode voxels were printed with a 75% degree of overlap in each layer. A curing step was performed after every two layers were printed. The cathode material included NCMA as the active material. The resulting cathode was assembled into an electrochemical cell including an anode and an electrolyte.

A comparative cathode was prepared using a wet slurry coating process in NMP as a solvent. The resulting cathode layer had a total dry thickness of 190 micrometers. The cathode material included NCMA as the active material. The resulting comparative cathode was assembled into a comparative electrochemical cell including an anode and an electrolyte. The NMP solvent drying rate was adjusted to match the 40 m/min conveyance speed for an 8-meter dryer length.

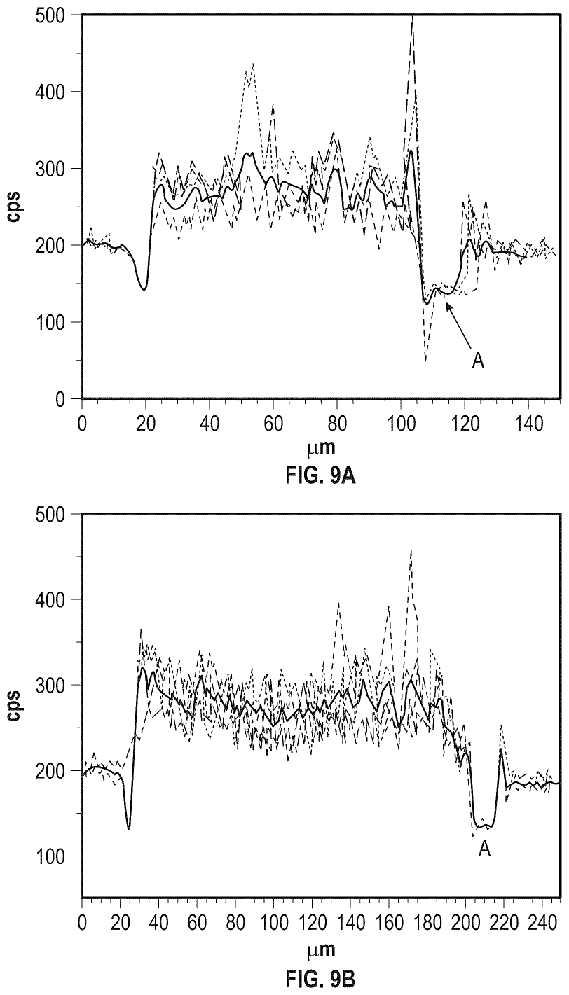

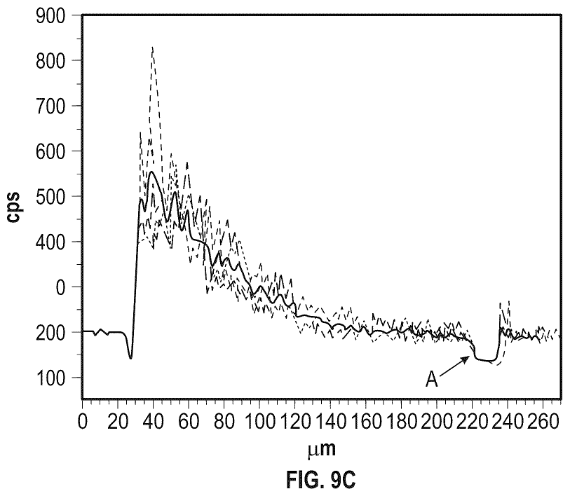

FIGS. 9A and 9B show the electron probe microanalysis (EPMA) cross-sections of the first and second working eLIFT cathode layers had a more uniform PVDF (binder) profile as compared with the cathode layer prepared by the wet slurry process in FIG. 9C. These results show that the cathodes have improved mechanical strength and improved cycle durability.

The terms “a” and “an” do not denote a limitation of quantity, but rather denote the presence of at least one of the referenced items. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears. Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A vehicle, comprising:
an electric motor; and
a battery pack electrically coupled to the electric motor, wherein the battery pack comprises an electrochemical cell comprising:
a cathode;
an anode; and
an electrolyte located between the cathode and the anode;
wherein the cathode comprises a plurality of cathode voxel layers, wherein each of the cathode voxel layers comprises a plurality of cathode voxels, and the plurality of cathode voxel layers is disposed on a cathode current collector, and
wherein the plurality of cathode voxel layers has a total thickness of 20 micrometers to 500 micrometers.

2. The vehicle of claim 1, wherein the plurality of cathode voxel layers has a total thickness of 30 micrometers to 250 micrometers.

3. The vehicle of claim 1, wherein each cathode voxel layer of the plurality of cathode voxel layers independently has a thickness of 10 micrometers to 120 micrometers.

4. The vehicle of claim 1, wherein the plurality of cathode voxel layers comprises:
a first plurality of cathode voxel layers disposed on the cathode current collector; and
a second plurality of cathode voxel layers disposed on the first plurality of cathode voxel layers,
wherein each cathode voxel layer of the first plurality of cathode voxel layers independently has a thickness of 10 micrometers to 20 micrometers, and
wherein each cathode voxel layer of the second plurality of cathode voxel layers independently has a thickness of 20 micrometers to 30 micrometers.

5. The vehicle of claim 1, wherein the cathode is prepared by:
providing a donor foil;
providing a carrier substrate disposed adjacent to the donor foil;
providing an optical system;
providing a current collector defined by an X-Y plane;
activating the optical system to generate a laser beam through the donor foil and the carrier substrate to create a first plurality of cathode voxels;
collecting the first plurality of cathode voxels on the current collector to form one or more first cathode voxel layers;
activating the optical system to generate a laser beam through the donor foil and the carrier substrate to create a second plurality of cathode voxels; and
collecting the second plurality of cathode voxels on the one or more first cathode voxel layers to form one or more second cathode voxel layers.

6. The vehicle of claim 5, wherein the cathode is further prepared by curing the one or more first cathode voxel layers before forming the one or more second cathode voxel layers.

7. The vehicle of claim 5, wherein the first plurality of cathode voxels comprises a first set of cathode voxels and a second set of cathode voxels, and the second plurality of cathode voxels comprises a third set of cathode voxels and a fourth set of cathode voxels,
wherein the first set of cathode voxels are spaced apart from the second set of cathode voxels along the X-Y plane, or the first set of cathode voxels at least partially overlap with the second set of cathode voxels along the X-Y plane, and
wherein the third set of cathode voxels are spaced apart from the fourth set of cathode voxels along the X-Y plane, or the third set of cathode voxels at least partially overlap with the fourth set of cathode voxels along the X-Y plane.

8. The vehicle of claim 7, wherein the first set of cathode voxels have a first thickness in a Z-direction perpendicular to the X-Y plane, the second set of cathode voxels have a second thickness in a Z-direction perpendicular to the X-Y plane, the third set of cathode voxels have a third thickness in a Z-direction perpendicular to the X-Y plane, the fourth set of cathode voxels have a fourth thickness in a Z-direction perpendicular to the X-Y plane, the first thickness is greater than the second thickness, and the third thickness is greater than the fourth thickness.

9. An electrochemical cell, comprising:
a cathode;
an anode; and
an electrolyte located between the cathode and the anode;
wherein the cathode comprises a plurality of cathode voxel layers, wherein each of the cathode voxel layers comprises a plurality of cathode voxels, and the plurality of cathode voxel layers is disposed on a cathode current collector, and
wherein the plurality of cathode voxel layers has a total thickness of 20 micrometers to 500 micrometers.

10. The electrochemical cell of claim 9, wherein the plurality of cathode voxel layers has a total thickness of 30 micrometers to 250 micrometers.

11. The electrochemical cell of claim 9, wherein each cathode voxel layer of the plurality of cathode voxel layers independently has a thickness of 10 micrometers to 120 micrometers.

12. The electrochemical cell of claim 9, wherein the plurality of cathode voxel layers comprises:
a first plurality of cathode voxel layers disposed on the cathode current collector; and
a second plurality of cathode voxel layers disposed on the first plurality of cathode voxel layers,
wherein each cathode voxel layer of the first plurality of cathode voxel layers independently has a thickness of 10 micrometers to 20 micrometers, and
wherein each cathode voxel layer of the second plurality of cathode voxel layers independently has a thickness of 20 micrometers to 30 micrometers.

13. The electrochemical cell of claim 9, wherein the cathode is prepared by:
providing a donor foil;
providing a carrier substrate disposed adjacent to the donor foil;
providing an optical system;
providing a current collector defined by an X-Y plane;
activating the optical system to generate a laser beam through the donor foil and the carrier substrate to create a first plurality of cathode voxels;
collecting the first plurality of cathode voxels on the current collector to form one or more first cathode voxel layers;
activating the optical system to generate a laser beam through the donor foil and the carrier substrate to create a second plurality of cathode voxels; and
collecting the second plurality of cathode voxels on the one or more first cathode voxel layers to form one or more second cathode voxel layers.

14. The electrochemical cell of claim 13, wherein the first plurality of cathode voxels comprises a first set of cathode voxels and a second set of cathode voxels, and the second plurality of cathode voxels comprises a third set of cathode voxels and a fourth set of cathode voxels,
wherein the first set of cathode voxels are spaced apart from the second set of cathode voxels along the X-Y plane, or the first set of cathode voxels at least partially overlap with the second set of cathode voxels along the X-Y plane, and
wherein the third set of cathode voxels are spaced apart from the fourth set of cathode voxels along the X-Y plane, or the third set of cathode voxels at least partially overlap with the fourth set of cathode voxels along the X-Y plane.

15. The electrochemical cell of claim 14, wherein the first set of cathode voxels have a first thickness in a Z-direction perpendicular to the X-Y plane, the second set of cathode voxels have a second thickness in a Z-direction perpendicular to the X-Y plane, the third set of cathode voxels have a third thickness in a Z-direction perpendicular to the X-Y plane, the fourth set of cathode voxels have a fourth thickness in a Z-direction perpendicular to the X-Y plane, the first thickness is greater than the second thickness, and the third thickness is greater than the fourth thickness.

16. A method of preparing a cathode of an electrochemical cell for an electric vehicle, wherein the electrochemical cell comprises the cathode, an anode, and an electrolyte located between the cathode and the anode, the method comprising:
providing a donor foil;
providing a carrier substrate disposed adjacent to the donor foil;
providing an optical system;
providing a current collector defined by an X-Y plane;
activating the optical system to generate a laser beam through the donor foil and the carrier substrate to create a first plurality of cathode voxels;
collecting the first plurality of cathode voxels on a current collector to form one or more first cathode voxel layers;
activating the optical system to generate a laser beam through the donor foil and the carrier substrate to create a second plurality of cathode voxels; and
collecting the second plurality of cathode voxels on the one or more first cathode voxel layers to form one or more second cathode voxel layers,
wherein the one or more first cathode voxel layers and the one or more second cathode voxel layers have a total thickness of 20 micrometers to 500 micrometers.

17. The method of claim 16, wherein the one or more first cathode voxel layers and the one or more second cathode voxel layers have a total thickness of 30 micrometers to 250 micrometers.

18. The method of claim 16, wherein each of the one or more first cathode voxel layers independently has a thickness of 10 micrometers to 120 micrometers.

19. The method of claim 16, wherein the first plurality of cathode voxels comprises a first set of cathode voxels and a second set of cathode voxels, and the second plurality of cathode voxels comprises a third set of cathode voxels and a fourth set of cathode voxels,
wherein the first set of cathode voxels are spaced apart from the second set of cathode voxels along the X-Y plane, or the first set of cathode voxels at least partially overlap with the second set of cathode voxels along the X-Y plane, and
wherein the third set of cathode voxels are spaced apart from the fourth set of cathode voxels along the X-Y plane, or the third set of cathode voxels at least partially overlap with the fourth set of cathode voxels along the X-Y plane.

20. The method of claim 19, wherein the first set of cathode voxels have a first thickness in a Z-direction perpendicular to the X-Y plane, the second set of cathode voxels have a second thickness in a Z-direction perpendicular to the X-Y plane, the third set of cathode voxels have a third thickness in a Z-direction perpendicular to the X-Y plane, the fourth set of cathode voxels have a fourth thickness in a Z-direction perpendicular to the X-Y plane, the first thickness is greater than the second thickness, and the third thickness is greater than the fourth thickness.
